(19) United States
(12) Patent Application Publication
(10) Pub. No.: US 2002/0066527 A1
(43) Pub. Date: Jun. 6, 2002

(54) Process of making self-adhesive decorative stickers

(76) Inventor: Shih- Feng Lee, Taipei (TW)

Correspondence Address: Shih Feng Lee, PO BOX 82-144, TAIPEI, TW

(21) Appl. No.: 09/726,353

(22) Filed: Dec. 1, 2000

(51) Int. Cl. B32B 31/00; B32B 33/00; B32B 31/12; B32B 31/18

(52) U.S. Cl. 156/258; 156/263; 156/280

(57) ABSTRACT

A process of making self-adhesive decorative stickers includes the steps of adhering double-sided adhesive papers to upper and lower layers of a non-malleable sheet of paper; using a mold to punch out main members of different shapes; punching upper-layer paper blank of the main members to form corresponding cutting lines; after tearing off corresponding upper paper blank for adhering decorative articles to the upper adhesive paper, tearing off the remaining upper-layer paper blank outside of the corresponding positions; and sprinkling tinsel powders evenly on the portion outside of the decorative articles and securing the decorative articles using a bonding glue so as to form a decorative sticker. After tearing off the lower-layer paper blank, the decorative sticker can be adhered to a user's body, a planar pattern, an object, etc., for decorative purposes.

### BACKGROUND OF THE INVENTION

(a) Field of the Invention

The present invention relates to a process of making self-adhesive decorative stickers, more particularly to a process of making attractive decorative stickers that can be freely attached to different objects.

Description of the Prior Art

Conventional decorative stickers generally have a bottom face provided with a back adhesive or double-sided adhesive so as to be adhered to the user's body or different objects. Since the conventional decorative stickers are composed of two different components only, their appearance is monotonous and cannot be enhanced.

### SUMMARY OF THE INVENTION

The present invention relates to a process of making self-adhesive decorative stickers, more particularly to a process of making attractive decorative stickers that can be freely attached to different objects.

The object of this invention is to provide a process of making self-adhesive decorative stickers in which decorative articles of different shapes and colors are arranged on a main member to provide the decorative sticker with more variety in terms of appearance so as to enhance the utility of the decorative sticker.

According to the above-mentioned process, double-sided adhesive papers are respectively adhered to upper and lower layers of a non-malleable, air-permeable and soft sheet of paper, and using molds to punch out decorative main members of different shapes.

According to the above-mentioned process, the upper paper blank of the decorative main members are punched to form corresponding cutting lines, and the corresponding upper paper blank is torn off for adhering decorative articles to the upper adhesive paper.

According to the above-mentioned process, after adhering the decorative articles to the corresponding upper adhesive paper, the remaining upper paper blank outside the corresponding portions is torn off, and tinsel powders are sprinkled evenly on the portion of the adhesive paper outside the decorative articles so as to form a complete decorative sticker.

According to the above-mentioned process, a release plastic sheet is punched to form a corresponding shallow recess of the shape of the decorative sticker for adhering of the decorative sticker product thereto so as to facilitate packaging.

The foregoing objects and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts. Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIGS. 1 and 2 are schematic views illustrating formation of paper blanks according to the invention;

FIG. 3 is a schematic view illustrating formation of main members according to the invention;

FIG. 4 is a schematic view illustrating forming of registered cutting lines according to the invention;

FIG. 5 is a schematic view illustrating attachment of decorative articles according to the invention;

FIG. 6 is a schematic view illustrating sprinkling of tinsel powders according to the invention;

FIGS. 7 and 8 are schematic views illustrating packaging according to the invention; and

FIGS. 9 and 10 are schematic views illustrating use of the invention.

### DETAILED DESCRIPTION OF THE PREFERRED EMBODIMENT

For the purpose of promoting an understanding of the principles of the invention, reference will now be made to the embodiment illustrated in the drawings. Specific language will be used to describe same. It will, nevertheless, be understood that no limitation of the scope of the invention is thereby intended, such alterations and further modifications in the illustrated device, and such further applications of the principles of the invention as illustrated herein being contemplated as would normally occur to one skilled in the art to which the invention relates.

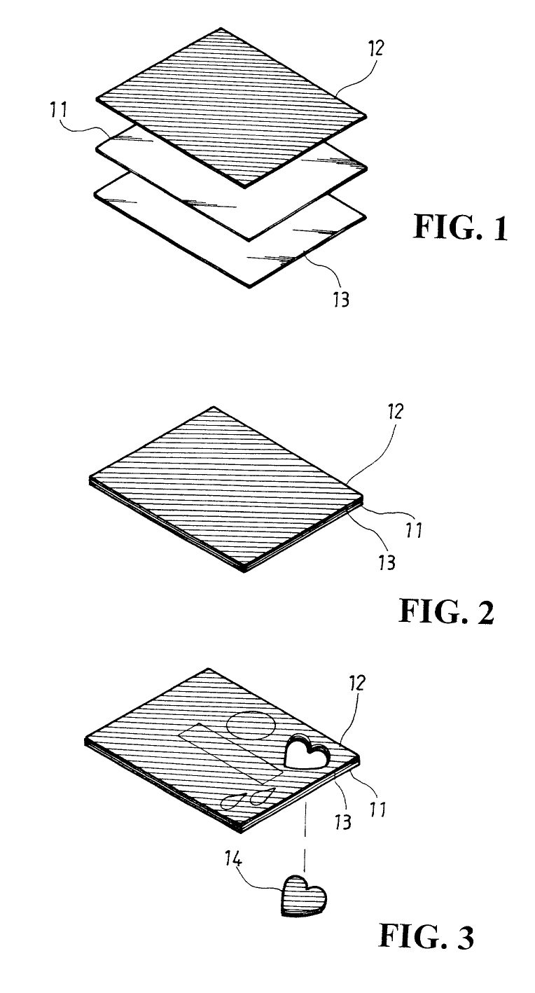

Referring to FIGS. 1 to 8, the process according to the present invention includes the following steps:

1. Adhering double-sided adhesive papers 12, 13 respectively to upper and lower layers of a non-malleable, air-permeable and soft paper 11 (see FIG. 1) so as to form a three-layer paper blank (see FIG. 2);

2. Using molds to punch out decorative main members 14 of different shapes (e.g. heart-shaped, rectangular, water-drop) (see FIG. 3);

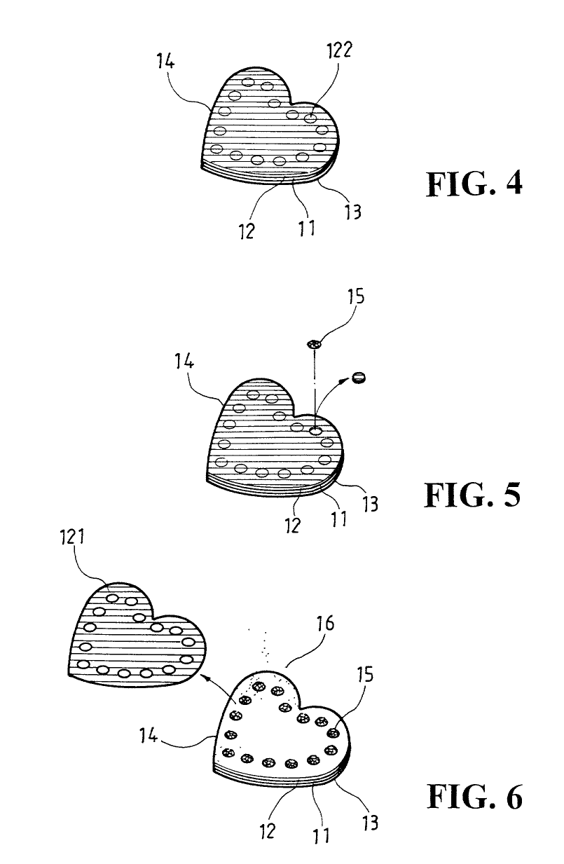

3. Punching the paper blank 121 of the upper adhesive paper 12 of the main members 14 to form corresponding cutting lines 122 (see FIG. 4);

4. Tearing off the portion of the paper blank within the corresponding cutting lines 122 to expose the portion of the adhesive paper 12 within and adhering decorative articles 15 of the same shape to the corresponding positions (see FIG. 5);

5. After adhering decorative articles 15 of different colors to all of the corresponding positions, tearing off the remaining paper blank 121 outside of the corresponding positions, and sprinkling tinsel powders 16 evenly on the portion outside of the decorative articles 15 (see FIG. 6);

6. Applying bonding glue to the peripheries of the decorative articles 15 to more firmly secure the decorative articles 15, and tearing away the paper blank 131 of the lower adhesive paper 13 to form a complete decorative sticker product 1 (see FIG. 7); and

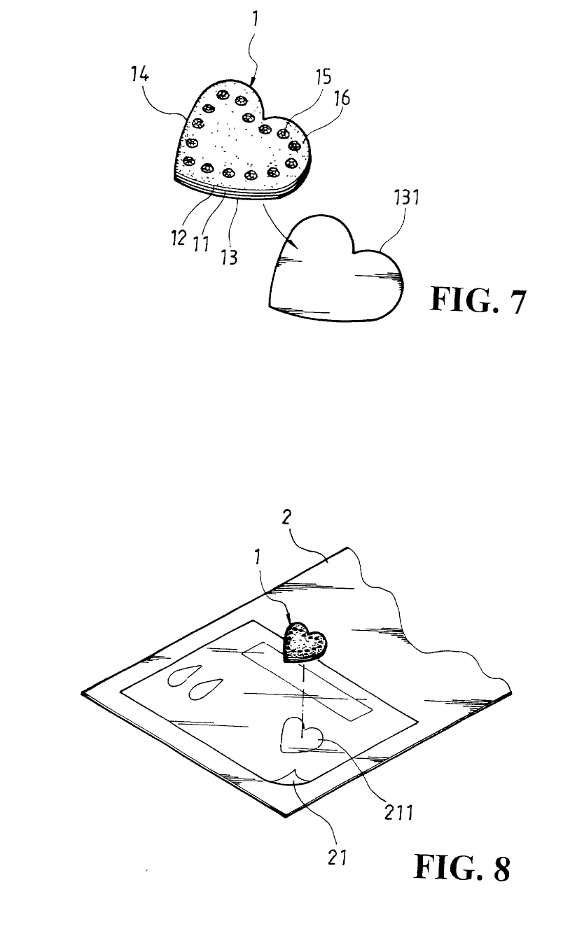

7. Punching a release plastic sheet 21 adhered to a sheet of paper 2 to form corresponding shallow recess 211 of the same shape as the decorative product 1 such that the decorative sticker 1 adheres to the corresponding shallow recess 211 so as to facilitate packaging (see FIG. 8).

In use, the decorative sticker 1 is removed from the release plastic sheet 21 to be adhered to different portions (ear lobes, cheeks, hands, etc) of the user's body to provide a decorative effect. Since the above-described process permits decorative articles of varying shapes and colors to be arranged on the main member 14, the decorative sticker 1 thus formed is beautiful and visually pleasing, and can enhance the value of the decorative sticker 1.

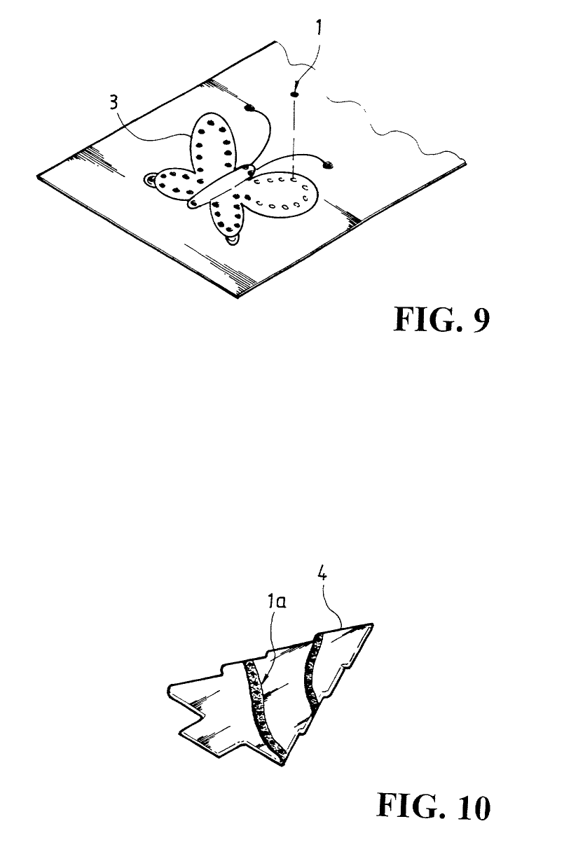

Referring to FIG. 9, the decorative sticker 1 can be adapted to be adhered to a planar printed pattern 3 to enhance the pattern 3. As shown in FIG. 10, a strip of decorative sticker 1a can be adhered to an ornament 4 to enhance the appearance thereof so that the ornament 4 appears more beautiful to the viewers.

In sum, the decorative main member with upper and lower double-sided adhesive papers can have decorative articles arranged thereon by means of the process of the invention so as to form nice decorative stickers.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A process of making self-adhesive decorative stickers, comprising the following steps:
adhering double-sided adhesive papers to upper and lower layers of a sheet of paper, respectively;
using a mold to punch out decorative main members of different shapes;
punching the paper blank of the upper adhesive sheet of the main members to form corresponding cutting lines;
tearing off the portion of the paper blank within the corresponding cutting lines and adhering decorative articles of the same shape to the adhesive paper at the corresponding positions;
after adhering the decorative articles to all of the corresponding positions, tearing off the remaining paper blank outside of the corresponding positions and sprinkling tinsel powders evenly on the portion outside of the decorative articles so as to form a complete decorative sticker product; and
after tearing off the paper blank of the lower adhesive paper of the decorative sticker product, adhering the same to a release plastic sheet to facilitate packaging.

2. The process according to claim 1, wherein the sheet of paper to which the upper and lower double-sided adhesive papers are adhered is of a non-malleable nature.

3. The process according to claim 1, wherein said decorative articles are make firm by applying a bonding glue to peripheries thereof after adhering of the adhesive papers.

4. The process according to claim 1, wherein the release plastic sheet to which the decorative sticker is adhered is pre-punched to form a corresponding shallow recess so as to facilitate attachment of the decorative sticker thereto.
